(19) United States
(12) Patent Application Publication
(10) Pub. No.: US 2008/0080175 A1
(43) Pub. Date: Apr. 3, 2008

(54) Conductive structure for LED lamp

(75) Inventors: George Lee, Chino, CA (US); Arthur Young, Chino, CA (US)

Correspondence Address: BIRCH STEWART KOLASCH & BIRCH, PO BOX 747, FALLS CHURCH, VA, 22040-0747, US

(73) Assignee: American Bright Optoelectronics Corp.

(21) Appl. No.: 11/657,604

(22) Filed: Jan. 25, 2007

(30) Foreign Application Priority Data
Sep. 29, 2006 (TW) 95217542

(51) Int. Cl. F21S 4/00

(52) U.S. Cl. 362/223; 362/217; 362/222

(57) ABSTRACT

The present invention is related to an improved conductive structure for an LED lamp and comprises: a tube housing having at least one LED unit therein; two conductive structures, which are connected to two ends of the tube housing and electrically connected to the LED; two end bases, which are electrically connected to and fastened on the two conductive structures; and an integrating base, two ends of the integrating base are connected to the two end bases for firmly combining the entire LED lamp.

### BACKGROUND OF THE INVENTION

1. Field of the Invention

The present invention generally relates to an improved conductive structure for an LED lamp, more particularly to an LED lamp being easily replaced and capable of projecting light to any arbitrary direction.

2. Description of the Prior Art

There are many types of traditional lamps, which are developed to a very top status presently. The applications for traditional lamps as paillette, crystal member, etc. are to offer aesthetic appearance and better illumination. On the contrary, such applications have a common defect, the maintenance difficulty. Most family lighting has the same problem and even more, such as power-waste. For example, the traditional light bulb may be fastened on the lamp by way of either screwing or insertion. After a period of time, the light bulb is hardly loosed while replacing it. Then the situation as the broken bulb is happened. On the other hand, the traditional lamps for shop windows are usually bar-type fluorescent lamps, neon lamps, spot lamps, etc. All the above mentioned lamps have the difficulties of focusing reflected and/or projected light and often as a result of wasting power. More, such traditional lamps are hardly replaced while in maintenance as well. For additional consideration, an outdoor signboard built on the side of a highway, to change or maintain the lights on the signboard shall depend on a tall stepladder, a long arm, etc. Hence, obviously the convenience for changing lamps is a very important factor.

Based on the issue of power-saving, lots of substitutions are available, some of them are gradually mass-produced. LED is a successful example. At first, LED is developed toward the application of indicator, but it moves to the application of illumination lately. The key factors for this approach are lower power consumption, lower cost per LED, variable colors, etc. However, the LED lamps for shop windows or outdoor signboards still have same inconveniences. To develop an improved LED lamp structure becomes significant.

### SUMMARY OF THE INVENTION

The primary objective of the present invention is to provide an improved conductive structure for an LED lamp to be replaced easily.

The second objective of the present invention is to provide the improved conductive structure for the LED lamp to solve the problem that the LED lamp in prior arts cannot focus the reflected and/or projected light on an arbitrary direction; the present invention is able to let the reflected and/or projected light be through any arbitrary direction.

An improved conductive structure for the LED lamp comprises: a tube housing having at least one LED unit therein; two conductive structures, which are connected to two ends of the tube housing and electrically connected to the LED unit; two end bases, which are electrically connected to and fastened on the two conductive structures; and an integrating base, two ends of the integrating base are connected to the two end bases for firmly combining the entire LED lamp.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic assembled view of a first preferred embodiment of the present invention;

FIG. 2 illustrates a schematic exploded view of the first preferred embodiment of the present invention;

FIG. 3 illustrates a schematic front view of the first preferred embodiment of the present invention;

FIG. 4 illustrates a schematic front view of a second preferred embodiment of the present invention;

FIG. 5 illustrates a schematic front view of a third preferred embodiment of the present invention;

FIG. 6 illustrates a schematic front view of a fourth preferred embodiment of the present invention;

FIG. 7 illustrates a schematic partially exploded view of the fourth preferred embodiment of the present invention;

FIG. 8 illustrates a schematic view of a first application of the fourth preferred embodiment of the present invention; and

FIG. 9 illustrates a schematic view of a second application of the fourth preferred embodiment of the present invention.

### DETAILED DESCRIPTION OF THE INVENTION

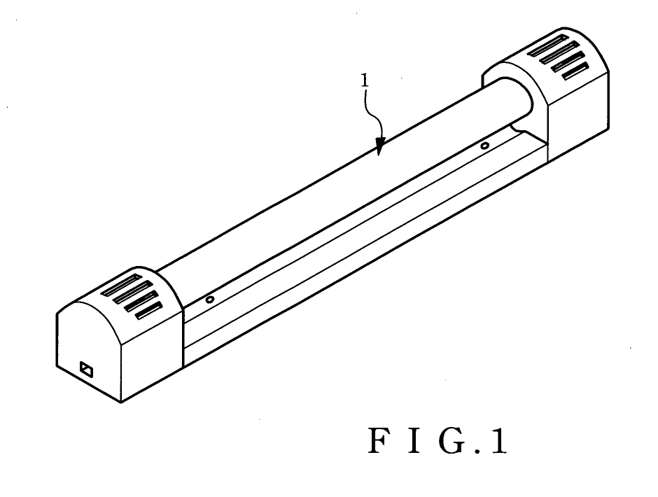

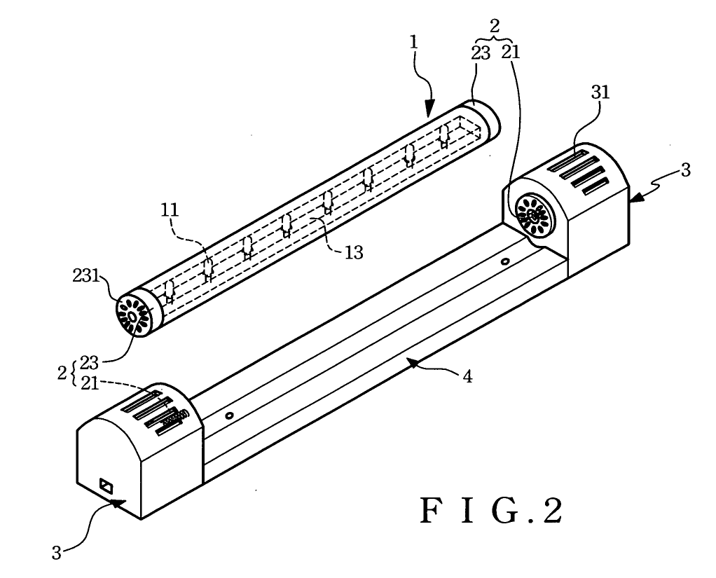

With reference to FIG. 1 and FIG. 2, which illustrate a schematic assembled view of a first preferred embodiment of the present invention and a schematic exploded view of the first preferred embodiment of the present invention. The first preferred embodiment comprises: a tube housing 1 having a plurality of LEDs 11 therein, wherein the tube housing 1 has a light-reflected PCB 13, which is fastened in the tube housing 1, the LEDs 11 are mounted on the surface or the both surfaces of the light-reflected PCB 13; two conductive structures 2, which are connected to two ends of the tube housing 1 and electrically connected to the LEDs 11, wherein the two conductive structures 2 have two metal springs 21 and two protective bases as two lamp covers 23 for the first preferred embodiment respectively, the two metal springs 21 are urged the two ends of the tube housing 1 for holding and electrically connected to the LEDs 11, the two lamp covers 23 are fastened to the two ends of the tube housing 1 and shaped as two hollow members so as to let the two metal springs 21 be through; two end bases 3, which are electrically connected to and fastened on the two conductive structures 2, the other two ends of the two metal springs 21 are fastened in the two end bases 3 respectively so as to hold the tube housing, the two end bases 3 and the two lamp covers 23 have a plurality of interstices 231 and 31 for heat-dissipation; and an integrating base as an aluminum connection base 4 for the first preferred embodiment, wherein the two ends of the aluminum connection base 4 are connected to the two end bases 3 for firmly combining the entire LED lamp.

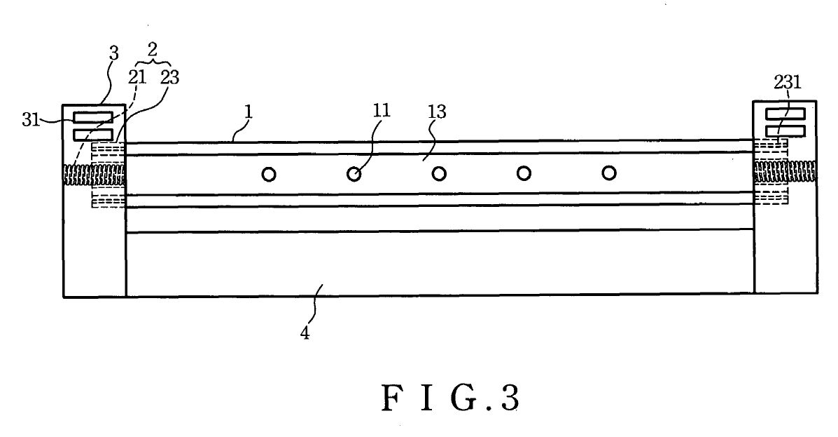

With reference to FIG. 3, which illustrates a schematic front view of the first preferred embodiment of the present invention. FIG. 3 clearly discloses that how the tube housing 1 are combined with the two end bases 3 and the aluminum connection base 4. Wherein the illuminating tube housing 1 is held by means of the urging forces of the two metal springs 21. Further that, due to the tube housing 1 being held along axial direction, the tube housing 1 can be rotated freely. Therefore, through the ways of the LEDs 11 projecting light, the light-reflected PCB 13 reflecting the light, and the tube housing 1 being rotated, the reflected and projected lights can be focused on an arbitrary direction.

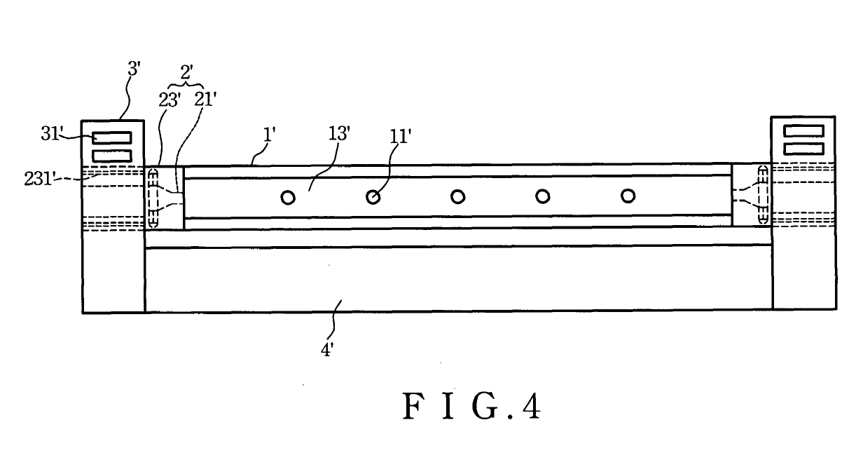

With reference to FIG. 4, which illustrates a schematic front view of a second preferred embodiment of the present invention. The second preferred embodiment comprises: a tube housing 1′ having a plurality of LEDs 11′ therein, wherein the tube housing 1′ has a light-reflected PCB 13′, which is fastened in the tube housing 1′, the LEDs 11′ is mounted on the surface or the both surfaces of the light-reflected PCB 13′; two conductive structures 2′, which are connected to two ends of the tube housing 1′ and electrically connected to the LEDs 11′, the two conductive structures 2′ have two elastic metal contacts 21′ and two conductive bases 23′ respectively, the two elastic metal contacts 21′ are urged the two ends of the tube housing 1′ for holding and electrically connected to the LEDs 11′, the other two ends of the two elastic metal contacts 21′ are fastened in the two conductive bases 23′ respectively; two end bases 3′, which are electrically connected to and fastened on the two conductive structures 2′, the two end bases 3′ and the two conductive structures 23′ have a plurality of interstices 231′ and 31′ for heat-dissipation, the conductive bases 23′ are fastened to the two end bases 3′ respectively so as to hold the tube housing; and an integrating base as an aluminum connection base 4′ for the second preferred embodiment, wherein the two ends of the aluminum connection base 4′ are connected to the two end bases 3′ for firmly combining the entire LED lamp.

According to FIG. 4, the tube housing 1′ of the second preferred embodiment can be rotated to let the reflected and projected lights be focused on an arbitrary direction.

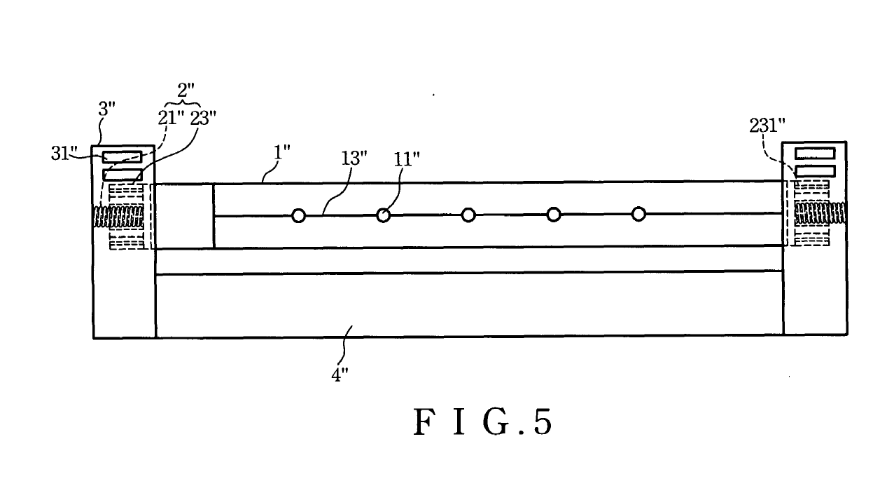

With reference to FIG. 5, which illustrates a schematic front view of a third preferred embodiment of the present invention. The third preferred embodiment comprises: a tube housing 1″ having a plurality of LEDs 11″ therein; two conductive structures 2″, which are connected to two ends of the tube housing 1″ and electrically connected to the LED 11″, that is, the LED 11″ are electrically connected to the two conductive structures 2″ by means of a wire 13″, the two conductive structures 2″ have two metal springs 21″ and two protective bases as two lamp covers 23″ for the third preferred embodiment respectively, the two metal springs 21″ are urged the two ends of the tube housing 1″ for holding and electrically connected to the LEDs 11″, the two lamp covers 23″ are fastened to the two ends of the tube housing 1″ and shaped as two hollow members so as to let the two metal springs 21″ be through; two end bases 3″, which are electrically connected to and fastened on the two conductive structures 2″, the other two ends of the two metal springs 21″ are fastened in the two end bases 3″ respectively so as to hold the tube housing 1″, the two end bases 3″ and the two the two lamp covers 23″ have a plurality of interstices 231″ and 31″ for heat-dissipation; and an integrating base as an aluminum connection base 4″ for the third preferred embodiment, wherein the two ends of the aluminum connection base 4″ are connected to the two end bases 3″ for firmly combining the entire LED lamp.

With reference to FIG. 5, the tube housing 1′ of the third preferred embodiment can be rotated to let the reflected and projected lights be focused on an arbitrary direction.

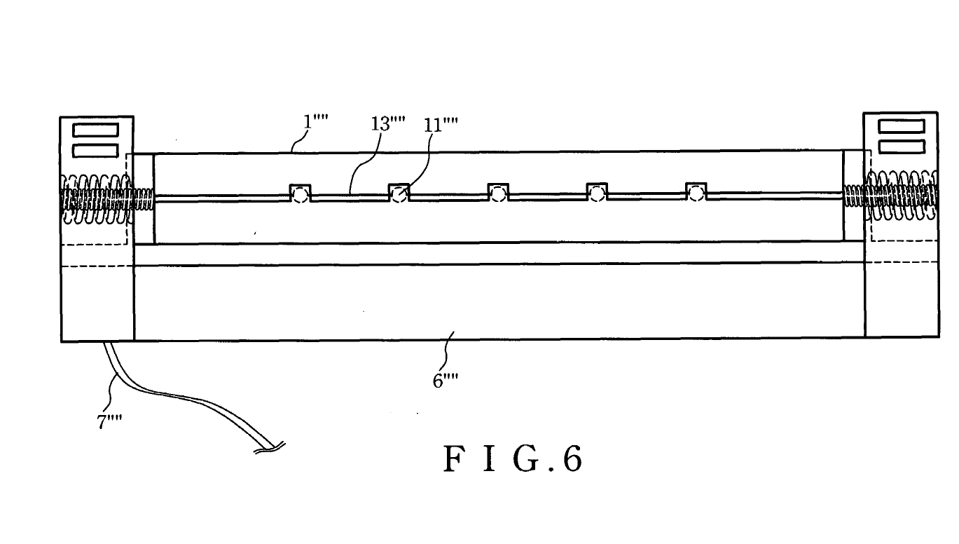

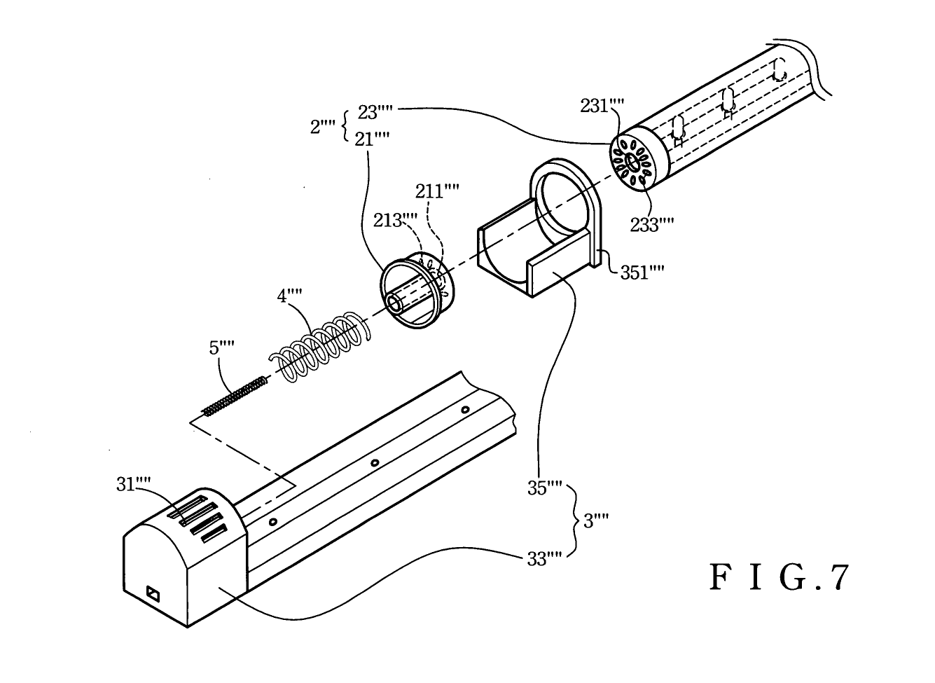

Referring to FIG. 6 and FIG. 7, which illustrate a schematic front view of a fourth preferred embodiment of the present invention and a schematic partially exploded view of the fourth preferred embodiment of the present invention. The fourth preferred embodiment comprises: a tube housing 1″″, which has at least one PCB 13″″ with at least one LED 11″″ therein; two protective structures 2″″, which have a first cover member 23″″ and a second cover member 21″″ respectively, the two first cover members 23″″ are female-connected to two ends of the tube housing 1″″ and capable of fastening the PCB 13″″, the surface comparative to the surface of each first cover member 23″″ female-connected to the tube housing 1″″ is loosely fit each second cover member 21″″; two end bases 3″″, which have a shell 33″″ and a support portion 35″″, the shell 33″″ and the support portion 35″″ are female-connected each other, each second cover member 21″″ is loosely fit a ring portion 351 of the support portion 35″″ in the shell 33″″, a pair of a first spring 4″″ and a second spring 5″″ are coaxial and disposed between the second cover member 21″″ and the inner surface of the shell 33″″ comparative to the second cover member 21″″, the first spring 4″″ has a greater diameter and is urged the second cover member 21″″ and the inner surface simultaneously, the end of the second spring is urged the inner surface and the other end is through an axial hole 211″″ of the second cover member 21″″ and an axial hole 231″″ of the first cover member 23″″ so as to keep the electrical connection of the two end bases 3″″ and the PCB at the time of assembly; and an integrating base 6″″, wherein two ends of the integrating base 6″″ are connected to the two end bases 3″″ for firmly combining the entire LED lamp; wherein the end of the second spring 5″″ urging the inner surface is electrically connected to a conductive member 7″″ in order to let the LED lamp be electrically connected to an outer power source, further, the two end bases 3″″, the two first cover members 23″″, and the two second cover members 21″″ have a plurality of interstices 31″″, 233″″; and 213″″ for heat-dissipation.

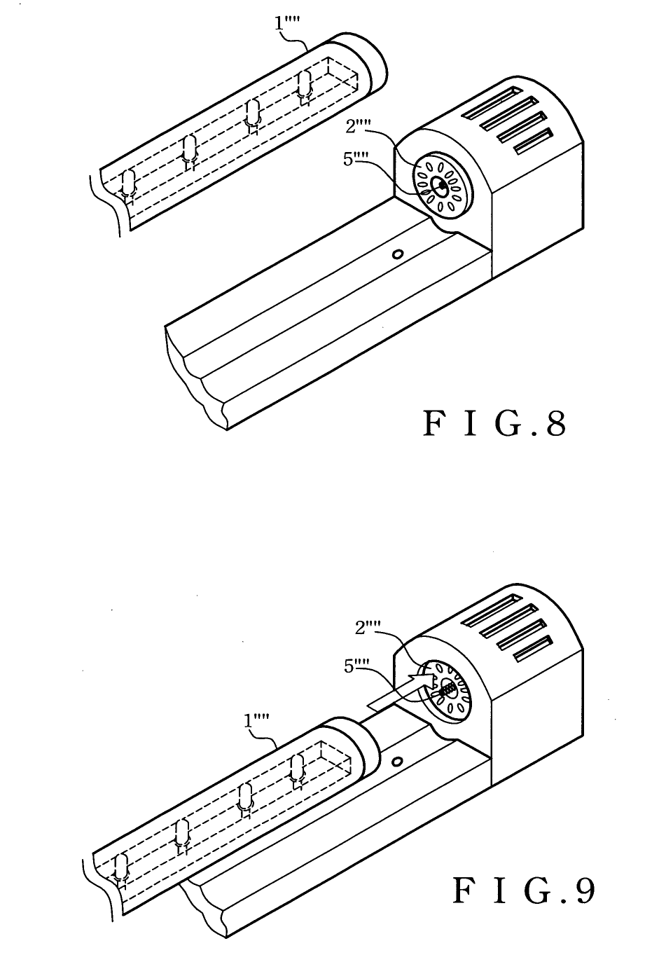

Please refer to FIG. 7, FIG. 8, and FIG. 9 simultaneously, FIG. 8 illustrates a schematic view of a first application of the fourth preferred embodiment of the present invention and FIG. 9 illustrates a schematic view of a second application of the fourth preferred embodiment of the present invention. FIG. 8 discloses the application before assembling the tube housing 1″″, that is, the second cover member 21″″ urged by the first spring 4″″ shields the second spring 5″″ so as to avoid danger. FIG. 9 discloses the application at the moment of assembling the tube housing 1″″, that is, the first spring 4″″ is urged by the first cover member 23″″, the first spring 4″″ is at the status of compression. Then the second cover member 21″″ is forced to enter into the shell 33″″ in order to explode the second spring 5″″. The second spring 5″″ is electrically connected to the PCB 13″″ of the tube housing 1″″.

As a conclusion, the improved conductive structure for the LED lamp of the present invention allows reflecting and projecting lights be focused on an arbitrary direction. The present invention is applied to the applications of shop window, signboard, vending machine, refrigerators etc. Since the improved conductive has the feature of rotating the illuminating tube housing for reflecting and projecting lights on the advertisement content, such as goods, words, etc. More, LED features a variety of colors, therefore it is suitable to light decoration, arts, etc. as well. Alternatively, the improved conductive structure is easily replaced so as to save the maintenance cost. Since the tube housing is clamped, the aforesaid problems when changing the traditional lights can be totally avoided. Moreover, the specific structure of the present invention prevents getting an electric shock.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. An improved conductive structure for an LED lamp, comprising:
a tube housing having at least one LED unit therein; two conductive structures, which are connected to two ends of the tube housing and electrically connected to the LED unit; two end bases, which are electrically connected to and fastened on the two conductive structures; and an integrating base, wherein the two ends of the integrating base are connected to the two end bases for firmly combining the entire LED lamp.

2. The improved conductive structure for the LED lamp according to claim 1, wherein the tube housing has a light-reflected PCB, which is fastened in the tube housing, the LED is mounted on the surface of the light-reflected PCB.

3. The improved conductive structure for the LED lamp according to claim 1, wherein the LED is electrically connected to the two conductive structures by means of a wire.

4. The improved conductive structure for the LED lamp according to claim 2, wherein the two conductive structures have two elastic metal contacts and two conductive bases respectively, the two elastic metal contacts are urged the two ends of the tube housing for holding and electrically connected to the LED, the other two ends of the two elastic metal contacts are fastened in the two conductive bases respectively, the conductive bases are fastened to the two end bases.

5. The improved conductive structure for the LED lamp according to claim 2, wherein the two conductive structures have two metal springs and two protective bases respectively, the two metal springs are urged the two ends of the tube housing for holding and electrically connected to the LED, the other two ends of the two metal springs are fastened in the two end bases respectively so as to hold the tube housing, the two protective bases are fastened to the two ends of the tube housing and shaped as two hollow members so as to let the two metal springs be through.

6. The improved conductive structure for the LED lamp according to claim 3, wherein the two conductive structures have two metal springs and two protective bases respectively, the two metal springs are urged the two ends of the tube housing for holding and electrically connected to the LED, the other two ends of the two metal springs are fastened in the two end bases respectively so as to hold the tube housing, the two protective bases are fastened to the two ends of the tube housing and shaped as two hollow members so as to let the two metal springs be through.

7. The improved conductive structure for the LED lamp according to claim 4, wherein the two end bases and the two conductive structures have a plurality of interstices for heat-dissipation.

8. The improved conductive structure for the LED lamp according to claim 5, wherein the two end bases and the two protective bases have a plurality of interstices for heat-dissipation.

9. The improved conductive structure for the LED lamp according to claim 6, wherein the two end bases and the two protective bases have a plurality of interstices for heat-dissipation.

10. An improved conductive structure for an LED lamp, comprising:
a tube housing having at least one PCB with at least one LED unit therein;
two protective structures having a first cover member and a second cover member respectively, the two first cover members being female-connected to two ends of the tube housing and capable of fastening the PCB, the surface comparative to the surface of each first cover member female-connected to the tube housing being loosely fit each second cover member;
two end bases having a shell and a support portion, the shell and the support portion being female-connected each other, each second cover member being loosely fit a ring portion of the support portion in the shell, a pair of a first spring and a second spring being coaxial and disposed between the second cover member and the inner surface of the shell comparative to the second cover member, the first spring having a greater diameter and being urged the second cover member and the inner surface simultaneously, the end of the second spring being urged the inner surface and the other end being through an axial hole of the second cover member and an axial hole of the first cover member so as to keep the electrical connection of the two end bases and the PCB at the time of assembly; and
an integrating base, wherein two ends of the integrating base are connected to the two end bases for firmly combining the entire LED lamp;
wherein the end of the second spring urging the inner surface is electrically connected to a conductive member in order to let the LED lamp be electrically connected to an outer power source.

11. The improved conductive structure for the LED lamp according to claim 10, wherein the two end bases, the two first cover members, and the two second cover members have a plurality of interstices for heat-dissipation.
